(19) United States
(12) Patent Application Publication
(10) Pub. No.: US 2004/0162206 A1
(43) Pub. Date: Aug. 19, 2004

(54) Security portfolio

(76) Inventor: Peter L. Lansing, Chesterfield, VA (US)

Correspondence Address: KENYON & KENYON, 1500 K STREET, N.W., SUITE 700, WASHINGTON, DC, 20005, US

(21) Appl. No.: 10/777,638

(22) Filed: Feb. 13, 2004

Related U.S. Application Data
(62) Division of application No. 10/202,679, filed on Jul. 25, 2002.

(51) Int. Cl. B31B 1/62

(52) U.S. Cl. 493/151

(57) ABSTRACT

The present invention provides security portfolios and apparatuses, which may be used to uniformly hold personal identification and travel or event information. In an embodiment of the present invention, a security portfolio is provided comprising a folded sheet having first and second panels defined by a fold portion, where each panel has an inside and an outside surface, and where the outside surface of the first panel includes an identification holder configured to receive a personal identification document related to security. In another embodiment of the present invention, a security apparatus is provided comprising an identification holder adapted to be fastened to a substantially solid surface portion, where the holder is configured to receive a personal identification document, related to security.

### FIELD OF THE INVENTION

This invention relates to the field of security and specifically to a security portfolio including an identification holder.

### BACKGROUND OF THE INVENTION

Since the events of Sep. 11, 2001, security and the number of associated security checkpoints have steadily increased across the nation. These security checkpoints are experienced by every traveler or person who attends special events. As the number and thoroughness of the security checkpoints increase, people having to navigate these checkpoints have experienced longer and longer delay times.

One reason for these increased delay times is the amount of time associated with having to retrieve a person's identification along with their travel or event documents. For example, an airline traveler has to present his driver's license and ticket numerous times before actually boarding a plane. At each of these security checkpoints, security personnel will ask to see the traveler's identification and ticket, which the traveler will then have to produce. However, there is currently no convenient way in which a traveler can organize his identification and ticket together so that they are easily accessible and visible. Therefore, each time a traveler reaches a security checkpoint, the traveler will waste time finding his identification and ticket within his luggage, pocket, or briefcase.

Similarly, patrons of special events, such as concerts and the theater have to pass through security checkpoints in order to gain access to a given event. As with traveling, there is no convenient way of organizing the patron's identification and event ticket such that all of the information necessary for entering the event may be easily seen and located.

### SUMMARY OF THE INVENTION

The present invention provides a security portfolio, which may be used to conveniently hold and view personal identification and travel or event information. In an embodiment of the present invention, a security portfolio is provided comprising a folded sheet having first and second panels defined by a fold portion, where each panel has an inside and an outside surface, and where the outside surface of the first panel includes an identification holder configured to receive a personal identification document related to security. The security portfolio also includes an opening in the outside surface of the first panel for securing a second document.

Yet another embodiment includes a security portfolio comprising a folded sheet having first, second, and third panels, where the first and second panel are defined by a first fold portion and the second and third panels are defined by a second fold portion. In addition, in this embodiment each panel has an inside and an outside surface where the inside of the first panel includes an identification holder configured to receive a portion of the identification document and the outside surface of the second panel is configured to removably secure a second document. Finally, the inside surface of the third panel is configured to secure another portion of the identification document.

In another embodiment of the present invention, a security apparatus is provided comprising an identification holder adapted to be fastened to a substantially solid surface portion, where the holder is configured to receive a personal identification document, related to security, therein. The security apparatus further includes a substantially solid surface portion, where the substantially solid surface portion is one of a travel document, a travel portfolio, a special event document, a special event portfolio, and a security document and the holder is fastened to the substantially solid surface portion.

In yet another embodiment of the present invention, a security apparatus is provided comprising a folded sheet having first and second panels defined by a fold portion where each panel has an inside and an outside surface. This embodiment further includes the outside surface of the first panel having an identification holder configured to receive a personal identification document related to security and the first panel further defines an opening in the outside surface thereof for securing a second document. Finally, this embodiment includes a second document secured by the first panel, wherein the second document is one of a travel document, a special event document, and a security document.

Another embodiment of the present invention includes a security apparatus comprising a folded sheet having first, second, and third panels, where the first and second panel are defined by a first fold portion and the second and third panels are defined by a second fold portion and each panel has an inside and an outside surface. This embodiment also includes the inside surface of the second panel having an identification holder configured to receive a portion of the identification document, the outside surface of the first panel is configured to removably secure a second document, and the inside surface of the second panel is configured to secure another portion of the identification document. Finally, this embodiment includes a second document secured by the first panel, where the second document is a travel document.

In yet another embodiment of the present invention, a security portfolio is provided, comprising a folded sheet having first and second panels defined by a fold portion, each panel having an inside and an outside surface, where the outside surface of the first panel includes means for holding a personal identification document, and where the first panel further includes means for securing a second document. In another embodiment another security portfolio is provided comprising, a folded sheet having first, second, and third panels, each panel having an inside and an outside surface, wherein the first and second panel are defined by a first fold portion and the second and third panels are defined by a second fold portion. The portfolio also includes on the inside surface of the first panel means for holding an identification document, the outside surface of the second panel includes means for securing a second document, and the inside surface of the third panel includes means for securing another portion of the identification document.

### BRIEF DESCRIPTION OF THE DRAWINGS

FIG. 1 shows a perspective view of an embodiment of the present invention in a closed position.

FIG. 2 shows a perspective view of the same embodiment as FIG. 1, except in an open position.

FIG. 3 shows a perspective view of another embodiment of the present invention in a closed position.

FIG. 4 shows a perspective view of the embodiment of FIG. 3, in a partially open position.

FIG. 5 shows a perspective view of the embodiment of FIG. 3, in a fully open position.

FIG. 6 shows a perspective view of another embodiment of the present invention.

### DETAILED DESCRIPTION

The present invention provides security portfolios and apparatus to be used by travelers and patrons of special events.

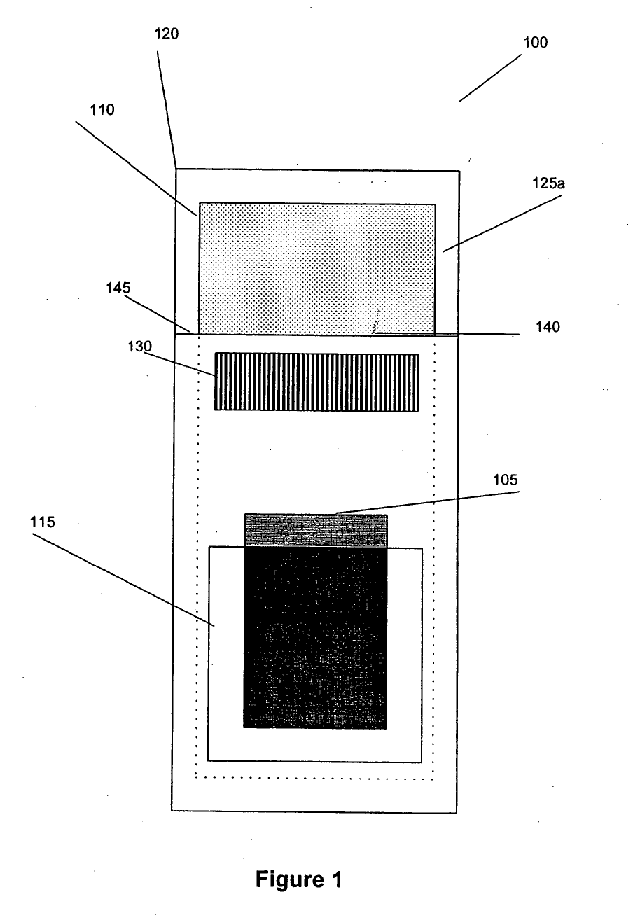

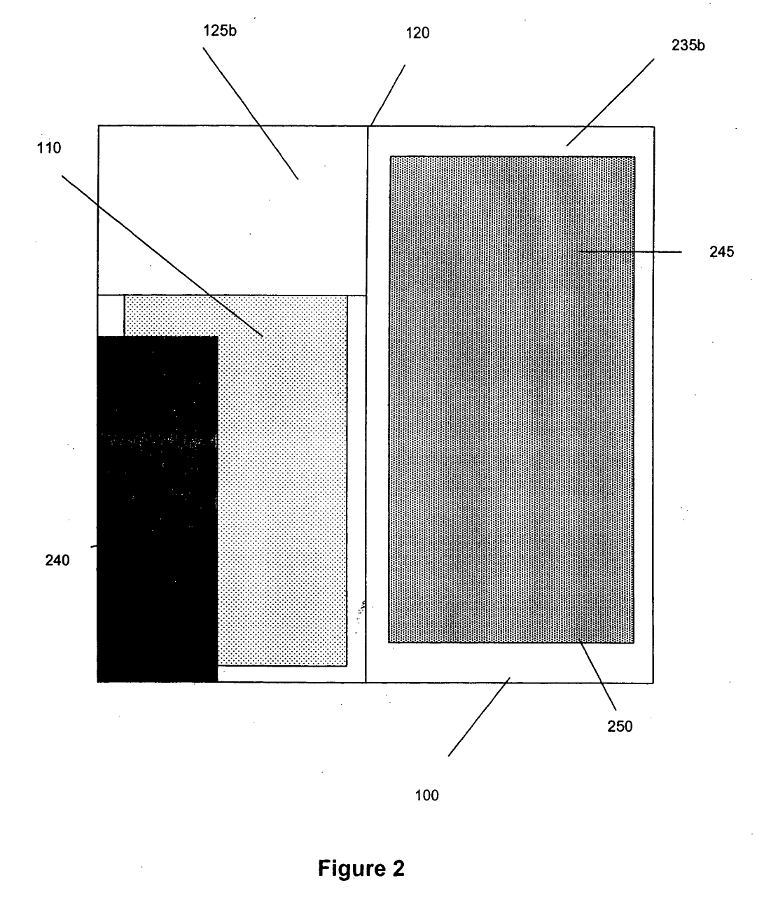

FIGS. 1 and 2 show a closed and open embodiment respectively, of a security portfolio 100 of the present invention, which may be used by travelers or patrons of special events. Like numbers are used to represent like features in the Figures.

The security portfolio 100 includes a personal identification holder 115, which holds a personal identification document 105 and means 140 for securing a second document 110.

Identification holder 115 may be formed from a sheet or pocket, which may be removably fastened to a substantially solid surface 125a. If the identification holder 115 is formed from a sheet, then a pocket is formed between the sheet and surface 125a. Alternatively, if the identification holder 115 is a pocket, then the pocket may be removably attached to surface 125a directly. The surface may be stiff or flexible and may be formed from any suitable material, such as paper, leather, or plastic. In addition, the substantially solid surface may be entirely solid or partially solid, such as a mesh. The sheet or pocket may be attached using adhesive or any other suitable fastening means, such as magnetic means or hook and loop fasteners. If identification holder 115 is a sheet, then for example, adhesive may be used along three edges in order to fasten the sheet to surface 125a. Alternatively, if identification holder 115 is a pocket, adhesive may be applied to the entire back surface or a portion thereof of identification holder 115 to fasten the pocket to the surface 125a. A portion of the sheet or pocket may be transparent and the sheet or pocket may be made from any suitable material, including transparent plastics.

The identification holder 115 may be fastened to security portfolio 100 or to any other substantially solid surface upon which it would be convenient to secure a personal identification document. For example, the identification holder 115 may be attached to a permanent travel boarding pass used by certain airlines. In this embodiment a traveler may place his personal identification in the identification holder on the boarding pass while passing through security and simply remove his personal identification when the boarding pass is requested, prior to boarding the plane.

Alternatively, in another embodiment, the identification holder 115 could be attached to a clipboard or other common device used by security personnel during security stops, such as traffic stops or customs questioning. Security personnel may include any type of state or federal police, customs personnel, private security personnel, or the like. By attaching the identification holder 115 to, for example, a clipboard, a security person could have the detained person's personal identification document conveniently and centrally located.

Returning to the embodiment shown in FIG. 1, a personal identification document 105 may be held by the identification holder 115. The personal identification document 105 either fits entirely within the identification holder 115 or partially within the holder 115. At least a portion of the personal identification document 105 may be visible through holder 115. Also, the orientation of the personal identification document 105 may be vertical, horizontal, diagonal, etc. depending on the desired fit.

In an alternative embodiment, the personal identification document 105 may directly removably attach or fasten to the security portfolio 100. For example, the personal identification document may have a magnet imbedded with in it or include an adhesive or a hook and loop fastener on its surface. If the personal identification document 105 includes means for directly removably fastening itself to the security portfolio 100, then if necessary, the security portfolio may include corresponding means for removably fastening the personal identification document 105 to it. For example, in this embodiment, the security portfolio 100 may also include a magnet or other removable fastening means such as a hook and loop fastener.

The security portfolio 100 may be constructed from a folded sheet of material or alternatively from two separate pieces of material attached along fold portion 120. A first fold 120 is shown in FIGS. 1 and 2. Fold 120 connects panels 125 and 235. Each panel has an outside surface 125a and 235a (not shown in FIG. 2) and an inside surface 125b and 235b. The outside surface of panel 125a includes a cut 140, which defines an opening in panel 125. This opening 140 may be adjusted and appropriately sized so that it removably secures travel document 110. In addition, when security portfolio 100 is in a closed configuration as shown in FIG. 1, travel document 110 is also removably secured by panel 235b (not shown in FIG. 1), which also secures the travel document 110.

FIG. 1 also shows an opening 130, which acts as a window and which may be formed by cutting a portion out of panel 125. Alternatively, opening 130 may be formed by making a portion of panel 125 transparent. The purpose of this opening 130 is to allow machine readable data, such as optical bar codes and magnetic strips, to be visible and readable by electronic, magnetic, etc. scanners. The location and size of the opening 130 may be adjusted and moved depending on the location of the machine readable data on the second document.

FIG. 2 shows an open configuration of the security portfolio 100. The back of the second document 110 is visible on panel 125b. As can be seen in this open configuration, securing means 240 may be used further to removably secure the second document 110. Securing means 240 may be anything suitable, such as, a piece of paper or plastic. On panel 235b, a window 250 is shown, through which a third document 245 may be visible. Window 250 may be any shape or size and made from any transparent material, which then may be attached to panel 235b. Window 250 may be adjusted to show the entire third document or a portion thereof.

The dimensions for security portfolio 100 will change with the desired use, as will the number of windows, pockets, and securing means, which may be adjusted to fit a desired application. For example, if the security portfolio 100 was to be used when flying, then the panels 125 and 235 could be sized to fit a standard boarding pass and ticket and personal identification holder 115 could be sized to fit a drivers license. Alternatively, if the security portfolio 100 was to be used for a cruise, then the thickness of the security portfolio 100; could be adjusted to fit the tickets and any type of coupon book provided by the cruise line. Similarly, if the security portfolio 100 was to be used for a concert, then it could be adjusted to fit smaller tickets and information on the concert. In addition, the third document window 245 as well as the third document could be removed if there was no need for this additional information. Alternatively, a second personal identification holder could be added to panel 235b in order to hold additional personal records, such as a birth certificate or a passport.

The personal identification document 105 discussed above may include any state, federal, or international identification document. Document as used throughout this specification may include any paper documentation with visible information and smart cards, such as credit cards that include imbedded data/information, such as electronic, magnetic, or bioinformatic data. Examples of these documents may include, driver's licenses, ID cards, homeland security ID cards, birth certificates, passports, or the like. The information contained on or in these personal identification documents may include printed information, electronic or magnetic data, and bioinformatic data, such as finger prints, retinal scan data, or DNA data.

The second document 110 may include any travel document or special event document, such as travel tickets, boarding passes, itineraries, concert tickets, theatre tickets, sporting event tickets, cruise tickets, boarding passes, special event invitations, or the like. The third document 245 may be additional travel or event information, such as an itinerary or receipt. Or any additional document, which may be related to the security portfolio's purpose.

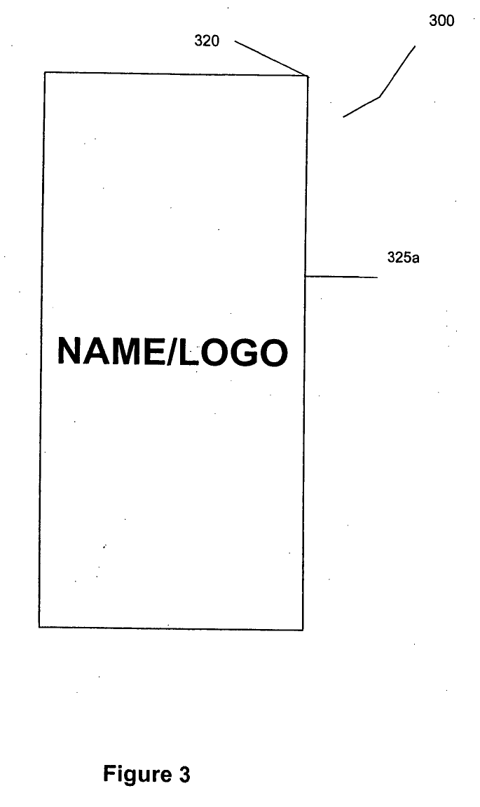

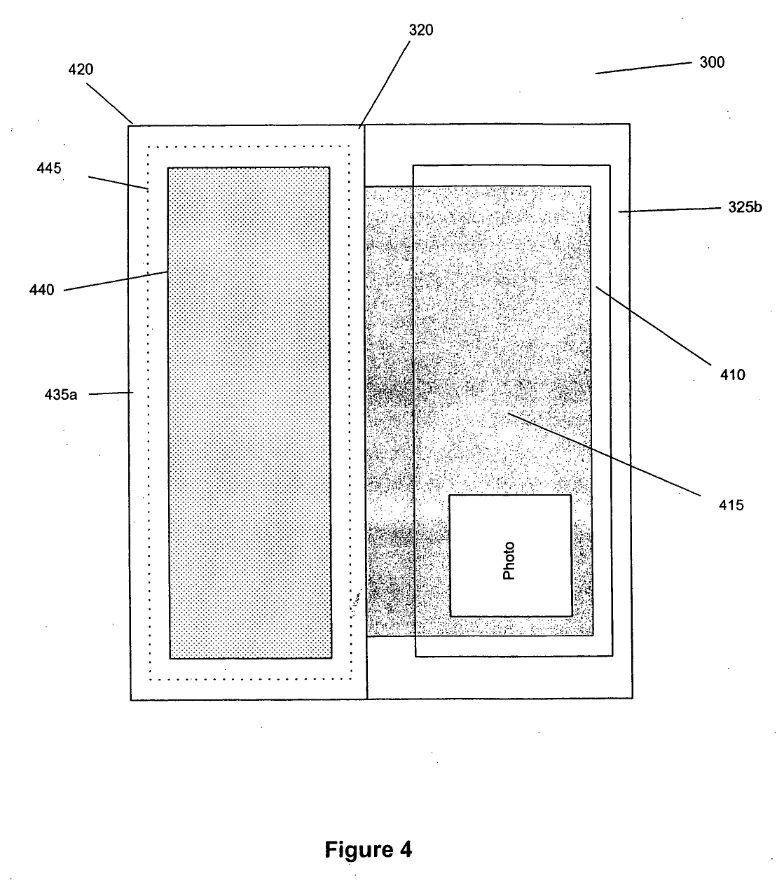

FIGS. 3 to 5 show another embodiment of the present invention. This embodiment is specifically designed for international travelers as it is capable of holding an international passport. FIGS. 3 and 4 show closed and partially open configurations of this embodiment. The security portfolio 300 is similar to security portfolio 100 as it may be a folded sheet of material or separate pieces attached by fold portions. However as compared to the previous embodiment, this embodiment has three panels 435, 520, and 325, instead of two. FIG. 3 shows panel 325 and fold portion 320. As in the previous embodiment, each panel has an outside and an inside surface, labeled a and b respectively. Printed on panel 325a could be the name or logo of a travel company, an event company, or any identification label that may be suitable.

FIG. 4 shows a partially open configuration of the present embodiment. The security portfolio 300 has been opened along fold portion 320 such that the inside surface of panel 325b and the outside surface of panel 435a are now shown. On panel 325b, an identification holder 410 may be attached, which contains a passport 415 including a picture. The identification holder 410 may be similar to that described in the previous embodiment, however the shape may be configured such that a portion of a passport 415 may be held within it. The identification holder 410 may be a sheet or pocket and at least a portion of the holder 410 may be transparent. The sheet or pocket may be made from any suitable material or plastic.

On panel 435a, a window similar to 245 of FIG. 2 may be shown. Through window 445 an international ticket may be visible. Window 445 may be attached to panel 435a by fastening means (not shown), which may include an adhesive. The adhesive preferably may be used to fasten three or four side edges of the window to panel 435a.

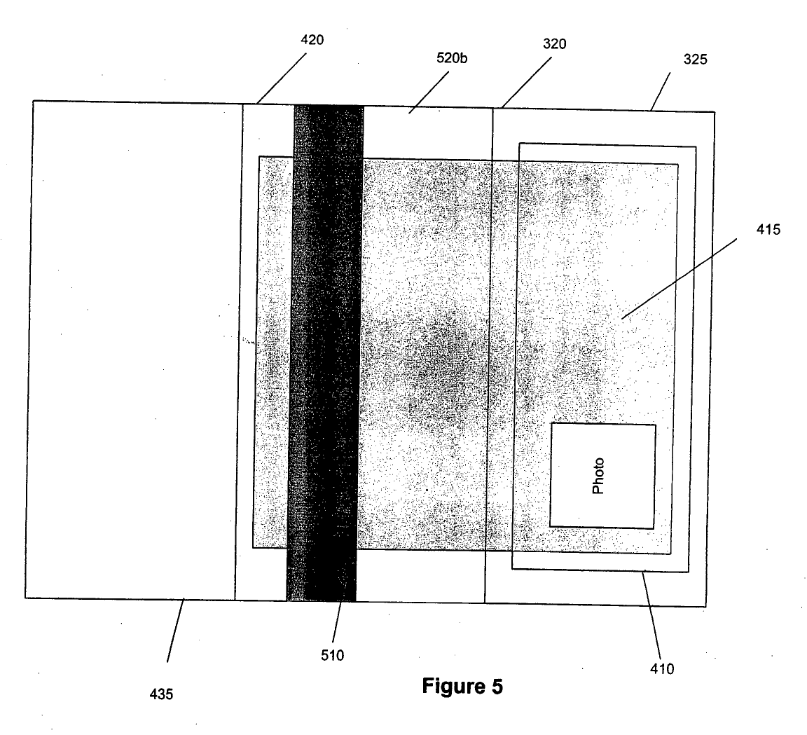

FIG. 5 shows a fully open configuration of the present embodiment. In FIG. 5, panel 435b is shown open along fold portion 420. Panel 520a becomes visible and securing means 510 removably secure another portion of passport 415. Securing means 510 may be any suitable structure, such as a strip of paper or plastic. In addition, securing means 510 may secure any portion of passport 415, such as just the corners or a strip across the entire passport 415. Additionally, securing means 510 may be partially or entirely transparent.

This embodiment of the present invention may be adjusted to fit the different layouts of international passports. For example, the location of the person's photograph present in passports may be located anywhere on the two pages. Therefore, the means for securing the passport may be adjusted. For example, if the person's photograph is on the opposite page from that which is shown in FIG. 5, the identification holder 410 and the securing means 510 may be switched. In addition, the security portfolio may open in an opposite direction from that shown in FIGS. 1-5. The direction for opening and folding would be dictated by the layout of the specific documents to be held within the portfolio.

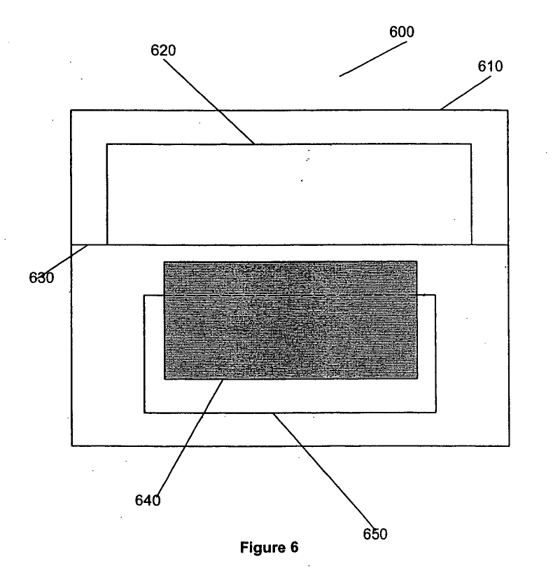

FIG. 6 shows another embodiment of the present invention. In this embodiment, the security portfolio 600 is constructed from a single sheet of material 610 with a second sheet of material 630 fastened thereto. The second sheet of material 630 may be fastened by any appropriate means, such as adhesive or staples. The fastening means may preferably fasten three side edges of the second sheet 630 to a portion of first sheet 610. In addition, the portfolio 600 can be constructed from any suitable material, such as paper, plastic, or leather.

A pocket is formed between sheets 610 and 630 in which a document 620 may be removably held. The document 620, may be an invitation or ticket(s) to a specific function, such as a fundraiser or party where there is a need for increased security. On the surface of sheet 630, an identification holder 650 may be removably fastened. The identification holder 650 may be similar to identification holder 115. However, in this embodiment the orientation of the identification holder 650 and the identification document 640 is shown in a horizontal orientation instead of vertical orientation. As discussed earlier, the orientation of the identification holder 650 may be adjusted to fit any type, size, or orientation of the identification document 640.

The present invention provides security portfolios and apparatuses. Although the present invention has been described with respect to several exemplary embodiments, there are many other variations of the above-described embodiments, which will be apparent to those skilled in the art, even where elements have not explicitly been designated as exemplary. It is understood that these modifications are within the teaching of the present invention, which is to be limited only by the claims appended hereto.

What I claim is:

1. A security portfolio comprising:
a folded sheet having first and second panels defined by a fold portion, each panel having an inside and an outside surface;
wherein the outside surface of the first panel includes an identification holder configured to receive a personal identification document related to security; and
wherein the first panel further defines an opening in the outside surface thereof for securing a second document.

2. The portfolio of claim 1, wherein at least a portion of the identification holder is transparent.

3. The portfolio of claim 1, wherein the identification holder is made of plastic.

4. The portfolio of claim 1, wherein the identification holder is configured such that a personal identification document fits at least partially within the holder.

5. The portfolio of claim 1, wherein the first panel further defines a second opening in the outside surface thereof for viewing a portion of the second document.

6. The portfolio of claim 5, wherein the second opening is a window.

7. The portfolio of claim 1, wherein the inside surface of the first panel is configured to removably secure the second document.

8. The portfolio of claim 7, wherein the inside surface of the second panel is configured to removably secure a third document.

9. The portfolio of claim 8, wherein at least a portion of the inside surface of the second panel is transparent.

10. A security portfolio comprising:
a folded sheet having first, second, and third panels, each panel having an inside and an outside surface, wherein the first and second panel are defined by a first fold portion and the second and third panels are defined by a second fold portion;
wherein the inside surface of the first panel includes an identification holder configured to receive a portion of an identification document;
wherein the outside surface of the second panel is configured to removably secure a second document; and
wherein the inside surface of the third panel is configured to secure another portion of the identification document.

11. The security portfolio of claim 10, wherein at least a portion of the outside surface of the second panel is transparent.

12. The security portfolio of claim 10, wherein at least a portion of the identification holder is transparent.

13. The portfolio of claim 10, wherein the identification holder is made of plastic.

14. The portfolio of claim 10, wherein the identification holder is configured such that a personal identification document fits at least partially within the holder.

15. A security apparatus comprising:
a substantially solid surface portion, wherein the substantially solid surface portion is one of a travel document, a travel portfolio, a special event document, a special event portfolio, and a security document; and
an identification holder adapted to be fastened to the substantially solid surface portion, the holder configured to receive a personal identification document therein, wherein the personal identification document is at least partially visible.

16. The security apparatus of claim 15, wherein at least a portion of the identification holder is transparent.

17. The security apparatus of claim 15, wherein the identification holder is plastic.

18. The security apparatus of claim 15, wherein the holder comprises one of a sheet or a pocket.

19. The security apparatus of claim 15, wherein the holder is fastened to the substantially solid surface portion by adhesive.

20. The security apparatus of claim 15, wherein a personal identification document fits at least partially within the holder.

21. A security apparatus comprising:
a folded sheet having first and second panels defined by a fold portion, each panel having an inside and an outside surface;
wherein the outside surface of the first panel includes an identification holder configured to receive a personal identification document related to security;
wherein the first panel further defines an opening in the outside surface thereof for securing a second document; and
a second document secured by the first panel, wherein the second document is one of a travel document, a special event document, and a security document.

22. The security apparatus of claim 21, wherein the second document is a boarding pass.

23. The security apparatus of claim 21, further wherein the outside surface of the second panel is configured to removably secure a third document; and
further comprising a third document secured by the second panel, wherein the third document is one of an additional travel document, special event document, and a security document.

24. The security apparatus of claim 23, wherein the third document is a receipt.

25. A security apparatus comprising:
a folded sheet having first, second, and third panels, each panel having an inside and an outside surface wherein the first and second panel are defined by a first fold portion and the second and third panels are defined by a second fold portion;
wherein the inside surface of the second panel includes an identification holder configured to receive a portion of an identification document;
wherein the outside surface of the first panel is configured to removably secure a second document;
wherein the inside surface of the second panel is configured to secure another portion of the identification document; and
a second document secured by the first panel, wherein the second document is a travel document.

26. The security apparatus of claim 25, wherein the second document is a boarding pass.

27. A security portfolio comprising:
a folded sheet having first and second panels defined by a fold portion, each panel having an inside and an outside surface;
wherein the outside surface of the first panel includes means for holding a personal identification document; and
wherein the first panel further includes means for securing a second document.

28. The security portfolio of claim 27, wherein the outside surface of the first panel further includes means for viewing a portion of a second document.

29. A security portfolio comprising:
a folded sheet having first, second, and third panels, each panel having an inside and an outside surface, wherein the first and second panel are defined by a first fold portion and the second and third panels are defined by a second fold portion;
wherein the inside surface of the first panel includes means for holding an identification document;
wherein the outside surface of the second panel includes means for securing a second document; and
wherein the inside surface of the third panel includes means for securing another portion of the identification document.
